(19) United States
(12) Patent Application Publication
(10) Pub. No.: US 2005/0081016 A1
(43) Pub. Date: Apr. 14, 2005

(54) Method and apparatus for program execution in a microprocessor

(76) Inventors: Ryuji Sakai, Hanno-shi (JP); Mitsuru Shimbayashi, Tokyo (JP)

Correspondence Address: Finnegan, Henderson, Farabow,;Garrett & Dunner, L.L.P., 1300 I Street, N.W., Washington, DC, 20005-3315, US

(21) Appl. No.: 10/948,525

(22) Filed: Sep. 24, 2004

(30) Foreign Application Priority Data
Sep. 30, 2003 (JP) 2003-339978
May 28, 2004 (JP) 2004-159232

(51) Int. Cl. G06F 15/00

(52) U.S. Cl. 712/1

(57) ABSTRACT

There is disclosed a microprocessor of a multithread system which comprises a register file constituted of a number of registers. The microprocessor creates instruction code offset data for allocating general-purpose registers in accordance with the number of registers used for each thread which is an execution unit module of a program.

### CROSS-REFERENCE TO RELATED APPLICATIONS

This application is based upon and claims the benefit of priority from the prior Japanese Patent Applications No. 2003-339978, filed Sep. 30, 2003 and No. 2004-159232, filed May 28, 2004, the entire contents of both of which are incorporated herein by reference.

### BACKGROUND OF THE INVENTION

1. Field of the Invention

The present invention generally relates to a microprocessor, and more particularly to a program execution system in which a register allocation facility has been improved for an execution unit module such as a thread.

2. Description of the Related Art

Generally, in a microprocessor, as the clock frequency becomes higher, memory access latency becomes a bottleneck in processor performance, i.e., program execution performance.

To solve the problem, an improvement in the method of using a cache memory, an improvement in a multithread system, and the like have been promoted. In all of these cases, however, another problem occurs, and thus no effective solutions have necessarily been provided.

On the other hand, in the field of microprocessors, as in the case of a processor of a reduced instruction set computer (RISC) system, high-speed program execution has been realized by mounting a number of general-purpose registers, and holding intermediate data of the time of data processing as long as possible in a register to reduce the number of times of storing/reading data in/from a memory (number of accessing times). That is, as it can improve memory access latency, the RISC system is effective for improving execution performance of a program.

However, in the case of the microprocessor which uses a number of general-purpose registers, a problem of an enlarged overhead of a context switch between threads occurs. That is, because the process is carried out by using many registers, the number of registers that need saving/restoring at the time of thread switching is increased, creating a problem of delayed response speed in thread switching.

To solve the aforementioned problem, there has been presented a system which can especially shorten an overhead time of a context switch between threads by limiting (fixing) general-purpose registers used by an execution unit module such as a thread (e.g., see Jpn. Pat. Appln. KOKAI Publication No. 2000-242505 and Carl A. Waldspurger and William E. Weihl. Register Relocation: Flexible Contexts for Multithreading. In Proceedings of the 20th International Symposium on Computer Architecture (ISCA), pages 120 to 130, June 1993. Gravinghoff. On the Realization of Fine-Grained Multithreading in Software. Ph.D. Thesis, F B Informatik, FernUniversitat Hagen, defended January 2002.).

Additionally, in the case of modularizing a program, by defining a method of using registers based on a procedure call convention, a value can be transferred between procedures, or held in a register over procedures. However, these constraints may disable effective use of many registers.

The problem can be overcome by employing a system of executing interprocedure register allocation in a compiler optimizing process (e.g., see Global Register Allocation at Link Time).

However, these systems necessitate static linkage of all the procedures, creating a problem of damaged modularity of program components.

The system of the conventional art cannot improve memory access latency because of ineffective use of the general-purpose registers. Thus, the conventional system is not effective for improving execution performance of the program.

### BRIEF SUMMARY OF THE INVENTION

In accordance with one embodiment of the present invention, there is provided an apparatus for program execution including facilities to efficiently use a number of registers.

The apparatus comprises a storage unit which stores an execution unit module of a program; a register file constituted of a group of registers necessary for the execution unit module; and a register allocation unit which creates start information indicating a start of a register number based on the number of registers used by the execution unit module, and allocates a register to each execution unit module from the register file in accordance with the start information.

### BRIEF DESCRIPTION OF THE SEVERAL VIES OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of an apparatus for program execution according to a first embodiment of the present invention;

FIG. 2 is a flowchart illustrating a register allocation process according to the first embodiment;

FIGS. 3A and 3B are views showing an example of instruction code offset data according to the first embodiment;

FIG. 4 is a view illustrating a mechanism of the register allocation process according to the first embodiment;

FIG. 5 is a view illustrating a mechanism of the register allocation process according to the first embodiment;

FIG. 6 is a view showing a state transition in a thread model according to the first embodiment;

FIG. 7 is a flowchart illustrating a program development process of a multithread system according to the first embodiment;

FIG. 8 is a flowchart showing a program execution process of the multithread system according to the first embodiment;

FIG. 9 is a view showing a specific example of a register allocation process of object variables according to the first embodiment;

FIG. 10 is a view showing a specific example of a register allocation process of object variables according to the first embodiment;

FIG. 11 is a view showing a specific example of a register allocation process of object variables according to the first embodiment;

FIG. 12 is a view showing a specific example of a register allocation process of object variables according to the first embodiment;

FIGS. 13A and 13B are views showing a specific example of a register allocation process of object variables according to the first embodiment;

FIGS. 14A and 14B are views showing a specific example of a register allocation process of object variables according to the first embodiment;

FIG. 15 is a flowchart illustrating a program development process according to a second embodiment;

FIG. 16 is a flowchart showing a program execution process according to the second embodiment;

FIG. 17 is a conceptual diagram showing an execution environment according to the second embodiment;

FIG. 18 is a conceptual diagram showing a dependency relation of an execution order according to the second embodiment;

FIG. 19 is a block diagram showing main portions of an apparatus for program execution according to a third embodiment;

FIG. 20 is a flowchart showing an operation process of a compiler according to the third embodiment;

FIG. 21 is a view showing a structure of register information generated by a compiler according to the third embodiment;

FIG. 22 is a flowchart illustrating a register number rewriting process according to the third embodiment;

FIG. 23 is a view showing a structure of a register use situation table according to the third embodiment; and

FIGS. 24A to 24C are views showing a concept of a program execution situation according to the third embodiment.

### DETAILED DESCRIPTION OF THE INVENTION

Next, preferred embodiments of the present invention will be described with reference to the accompanying drawings.

(First Embodiment)

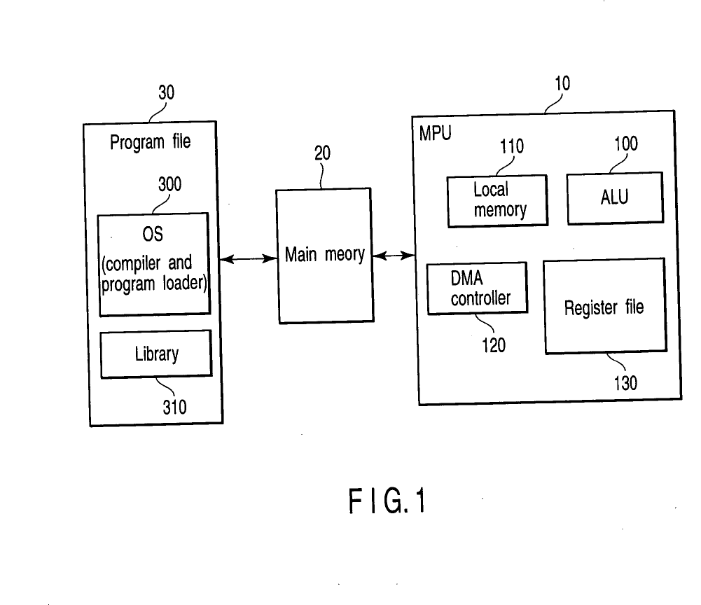

FIG. 1 is a block diagram showing a constitution of an apparatus for program execution in which a microprocessor (MPU) is a main portion according to the embodiment.

An MPU 10 is a processor of, e.g., an RISC system, which comprises a normal arithmetic and logical unit (ALU) 100, a local memory 110 to which access can be made at a high speed, a direct memory access (DMA) controller 120, and a register file 130 constituted of a number of general-purpose registers.

The DMA controller 120 comprises a memory access facility capable of controlling an input/output of data (including a program) between a main memory 20 and the local memory 110 by software.

A program file 30 is, e.g., a disk drive as hardware, and stores programs such as an operating system (OS) 300 including a compiler, a program loader and the like, various libraries 310, and applications on a disk medium. The MPU 10 executes these programs (including the OS, the compiler, and the program loader).

(Method for Program Execution in Thread Model)

The method for program execution according to the embodiment is equivalent to a normal multithread system. For example, the method divides a program (including a subroutine) such as the library 310 into a plurality of threads (execution unit modules) and executes the threads. The embodiment realizes a register allocation facility of allocating general-purpose registers (e.g., register banks) included in the register file 130 in accordance with the number of registers used by each thread when the compiler compiles the program. In other words, a process is executed which divides a number of general-purpose registers of the register file 130 into a plurality of register banks and manages the register banks, and allocates the register banks to each thread.

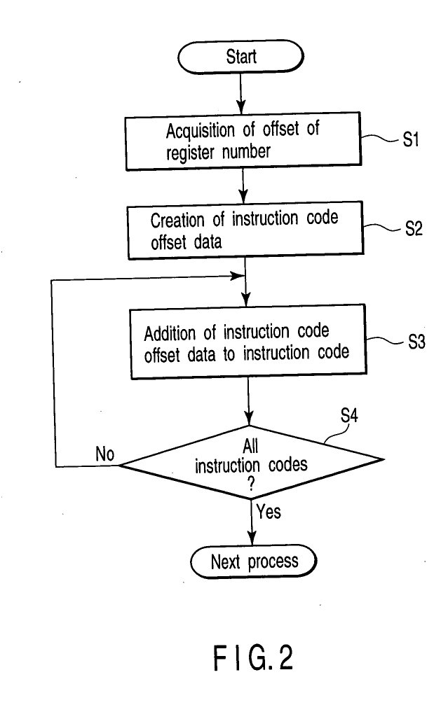

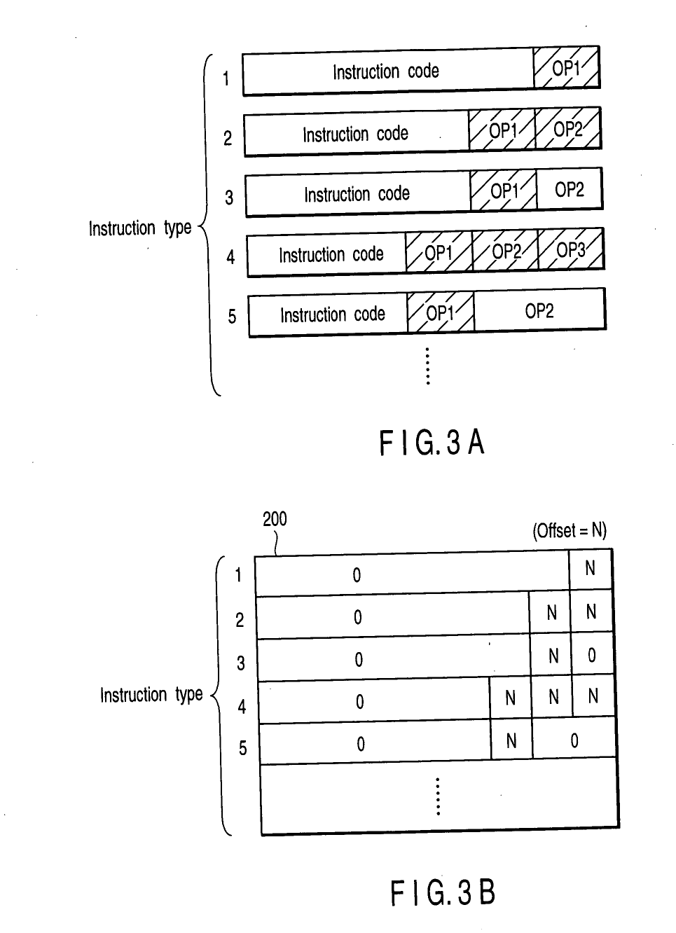

Hereinafter, the register allocation process in the thread model will be described by referring to a flowchart of FIG. 2, and FIGS. 3A and 3B.

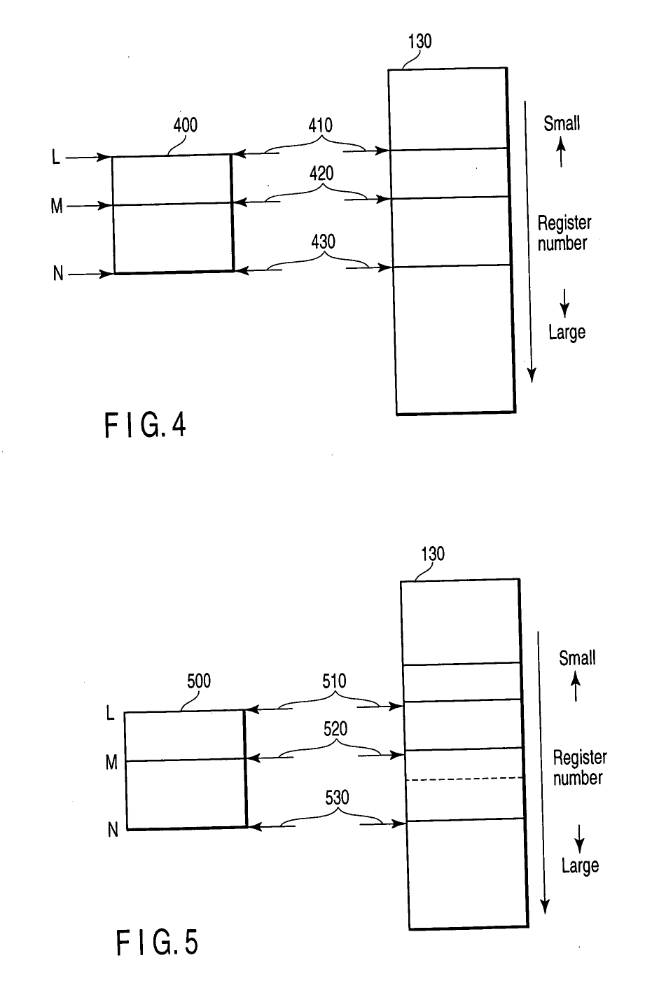

In this case, during program loading in which a program such as the library 310 is loaded from the program file 30 into the main memory 20, for each thread of the library 310, the program loader obtains an offset (e.g., 410 in FIG. 4) from the program file 30 to set a start register number of the register bank (plurality of general-purpose registers) in accordance with the number of registers used by the thread (step S1). Next, the program loader creates instruction code offset data in which the obtained offset is set, and saves the data in the main memory 20 (step S2).

As shown in FIG. 3B, instruction code offset data 200 is table information in which offsets (N) corresponding to register number fields are set for instruction format types (types 1 to 5) (i.e., register number conversion table information). As shown in FIG. 3A, an instruction format comprises instruction codes and operands (OP1 to OP3). In FIG. 3A, hatched operands mean register number fields. In the first data 200, the instruction codes are all set to “0” as shown in FIG. 3B.

Further, the program loader adds the instruction code offset data 200 to all the instruction codes of the program (library 310) to be loaded (steps S3, S4). At this time, the instruction codes are set in the fields of the instruction codes of the data 200.

As described above, according to the embodiment, the program loader creates the instruction code offset data 200 to allocate the general-purpose registers of the register file 130 to each thread during the program loading. All the instruction codes are converted into the program codes by using the instruction code offset data 200. Thus, in the MPU 10, a plurality of general-purpose registers (register banks) are normally allocated automatically to each thread of the program (library 310) transferred from the main memory 20 to the local memory 110 in accordance with the instruction code offset data 200.

As shown in FIG. 7, according to the embodiment, the number of registers for each thread is set during program development of a multithread system. A process during the program development is as follows. A program is divided into a plurality of threads (step S10). The number of registers necessary for each thread is obtained (step S11). Further, the general-purpose registers of the register file 130 are divided into register banks, and allocated to each thread (step S12).

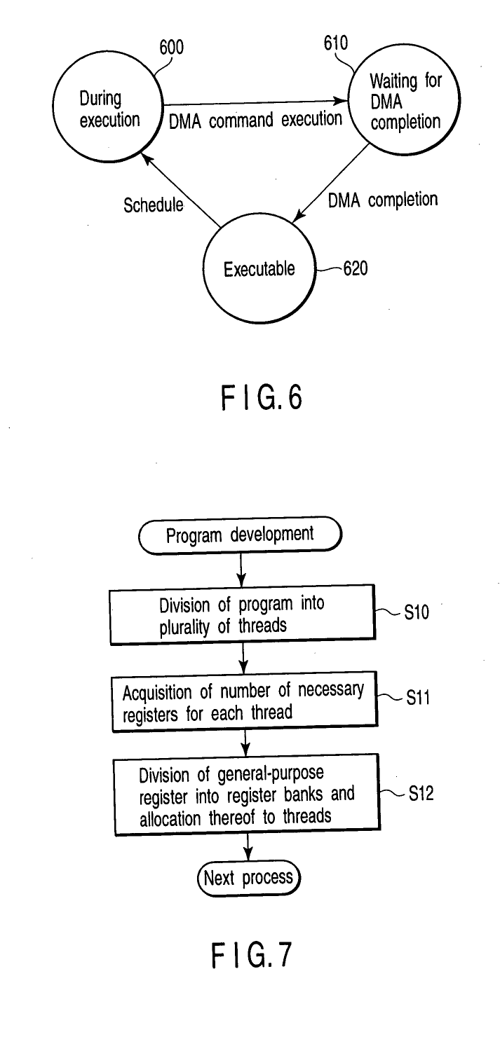

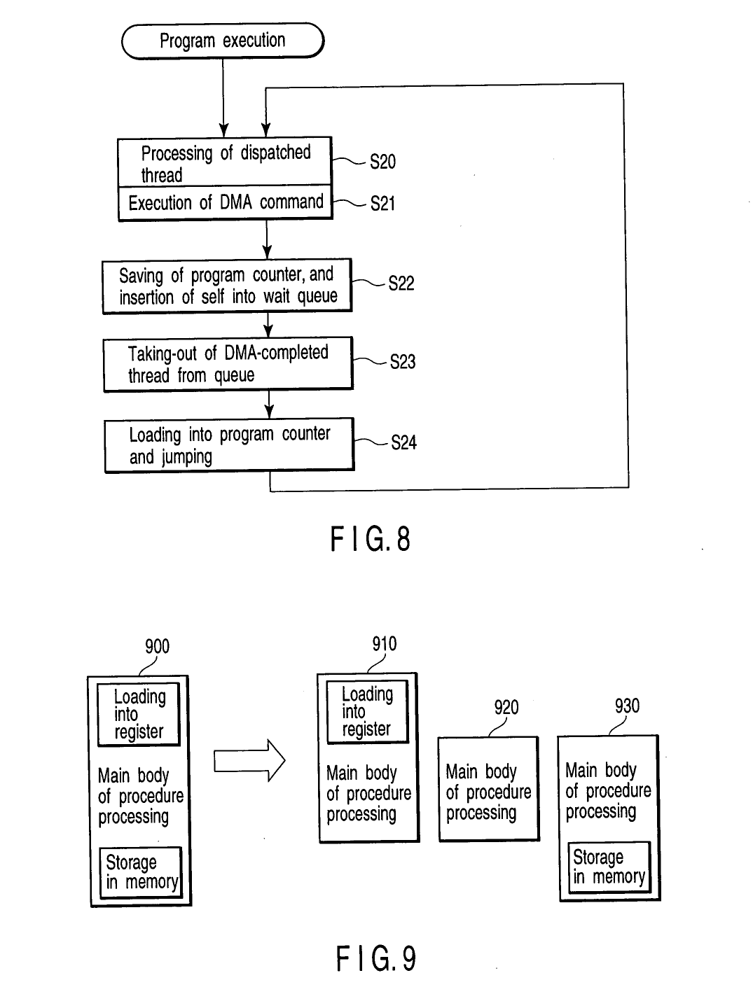

Next, a program execution process of the multithread system will be described with reference to FIGS. 6 to 8.

FIG. 6 shows a state transition of the thread. That is, a state 600 during thread execution, a state 610 of waiting for DMA completion, and an executable state 620 are shown.

In the MPU 10, a program dispatcher sets parameters used by the threads in the register, and then branches to a head address of a first executed thread (step S20). When the thread that is being executed executes a DMA command, a DMA command in a DMA library is executed (step S21). The thread saves its own program counter, and inserts itself into a wait queue (step S22).

Further, the thread takes out a thread in which a DMA command has been completed and which is in an executable state from a scheduling queue of each register bank (step S23). Then, the process jumps to a program counter of the thread (step S24).

Incidentally, according to the embodiment, in the method of dividing and allocating a number of general-purpose registers, the targets of allocation are assumed to be threads. However, the method can be applied to a case of coroutines (or functions). The difference between a thread and a coroutine is that processing is asynchronously switched by an event such as interruption in the case of the thread, while the coroutine has a facility of interrupting processing itself.

In short, according to the embodiment, if the general-purpose registers are allocated by procedure units (processing units of threads or coroutines), it is possible to execute procedure processing without any saving/restoring processing of registers necessary at the start and the end of the procedure. Moreover, since register allocation by thread or coroutine units enables high-speed thread or coroutine switching, it is possible to switch a thread or coroutine program by finer units.

(Method for Procedure Calling)

Now, description will be made of a specific example in which the register allocation facility of the embodiment is applied to a normal method for procedure calling. The procedure may mean a function calling unit.

To begin with, generally, the general-purpose registers of the microprocessor are classified into two, callee-saved (non volatile) and caller-saved (volatile), based on a calling convention or a linkage convention. Among the general-purpose registers, general-purpose registers for transferring arguments used during the procedure calling are also defined in the convention. Thus, even in the case of software modules (functions or libraries) developed by different programming languages, the modules can be mutually called in accordance with the convention.

In the case of the callee-saved general-purpose register, the convention stipulates that if there is a possibility of writing destruction by a called procedure, a value is saved at a head of the called procedure, and the saved value is restored before a return.

The caller-saved general-purpose register permits writing destruction by the called procedure. To obtain equal values of the register before and after calling on a procedure calling side, the general-purpose register must save a value before a procedure is called, and restore the saved value at a return from the procedure.

If procedure processing is divided into small units, an overhead of the processing of saving the value at the start of the procedure and restoring the value at the end in the callee-saved general-purpose register becomes relatively large. As a method of reducing the overhead, there is a mechanism of a register window as well known. In the case of the register window, the general-purpose register is switched by hardware for each procedure calling, and thus no saving/restoring processing of the general-purpose register is necessary.

Incidentally, in the method for procedure calling (specifically, function or method), data needed by called processing, or a variable held by the object is loaded into the register when the data or the variable is used, and an arithmetic operation is carried out. At this time, a result of the arithmetic operation must be rewritten in the memory before a return from the procedure (function or method).

In the case of calling the same procedure (function or method) again, an arithmetic operation has had to be carried out after the result of the rewriting is reloaded into the register. The same holds true in the register window system.

Thus, a mechanism is provided to enable flexible definition of the calling convention by applying the register allocation method of the embodiment, and it is possible to guarantee values of general-purpose registers allocated to the procedure over a plurality of procedure calling times. Accordingly, not only the saving/restoring processing of the callee-saved register necessary for each procedure calling is made unnecessary, but also the number of memory accessing times in the called procedure is reduced.

To begin with, in accordance with the calling convention, for example, callee-saved general-purpose registers are not set to be fixed registers but set as follows. Here, a mechanism is provided to allocate physical registers from the register file 130 when a shared library including a function is loaded.

As shown in FIG. 4, for example, if a register 400 used by the shared library is allocated from the register file 130, register numbers (registers 0 to L-1) of an area of receiving procedure arguments are set. The register number L is an offset value which indicates a start 410 of the received argument.

Additionally, register numbers (registers L to M-1) of an area used in a local procedure are set. The register number M is an offset value which indicates a start 420 of a calling parameter. Further, register numbers (registers M to N-1) of an area of transferring arguments in procedure calling are set. The register number N is an offset value which indicates a start 430 of a register used by a procedure.

Here, L, M and N are natural numbers which do not exceed the number of general-purpose registers included in the register file 130, and there is a relation of “mL<M<N”. The L, M and N may not be fixed values but different from one software module to another, or from one procedure to another.

The compiler of the embodiment optimizes the number of registers used in the procedure to be as small as possible, and adds information (equivalent to the M) of a start number of an argument register of a procedure (library) called by the procedure (or execution unit module). At this time, care must be taken not to sacrifice execution performance of a program to be compiled. For example, the addition of information regarding register use for each procedure can be realized by a format such as a reginfo section of an ELF file of an MIPS architecture.

FIG. 5 shows an allocation mechanism of a register 500 used in, e.g., a procedure called by the shared library. In this case, a register number L indicates a start 510 of a receiving argument. A register number M indicates a start 520 of a calling parameter. Further, a register number N indicates a start 530 of a register used by the procedure.

If a calling procedure is loaded during program execution, a loaded procedure instruction is scanned by using information of the register number M, and M is added to a value of a register field. A stack pointer is eliminated if a stack is used, and a program counter is also eliminated if it is present in the general-purpose register.

By the aforementioned mechanism of the register allocation processing of the embodiment, in the procedure calling method, it is possible to eliminate the necessity of saving/restoring processing of the general-purpose registers at the start and the end of the called procedure.

Next, regarding the variable register allocation in the method of a plurality of procedure calling times, description will be made of a specific example of object variable register allocation processing in an object-oriented program with reference to FIGS. 9 to 14B.

In the object-oriented program, access to variables held by the object is often carried out by calling a method defined by the object. In such a case, if the same method is repeatedly called, loading/restoring processing of the register of the object variables is executed in a complex manner, leading to a reduction in processing efficiency. To solve this problem, the called method is expanded in-line during program compiling.

In this way, the entire processing can be optimized on the procedure calling side without using the procedure calling method. For the repeated access to the object variables, if reading is executed from the memory into the register in a first round, the operation can be access to the register thereafter. Thus, an efficient execution module can be provided.

On the other hand, if the in-line expansion is used many times, a size of an object code is increased. Thus, in an incorporated system in which strict restrictions are imposed on a memory size, only limited use may be permitted, and execution performance may be reduced on the contrary because cache mistakes occur in a complex manner. The in-line expansion method can not be used in the dynamically coupled library or the object method.

Next, possibility of flexibly dealing with the process by the flexible calling convention realized by the embodiment is shown. In the description below, an external procedure means a procedure undefined in a complied software module.

The external procedure may possibly be taken into the entire module when the software module is linked. Alternatively, an execution form of loading from the file into the memory may be employed at a point of time when it is necessary during execution.

To begin width, as described above, the compiler adds information of a start number of a register for transferring procedure calling argument by a module unit or a procedure unit. For example, this information addition method comprises the following process.

At a first stage, s start number of a register for transferring an external procedure calling argument is set in the entire module. For example, this start number is set to a maximum value of the register used in the entire module.

At a second stage, an external procedure in which overlapping of used registers is prevented is picked up from called external procedures. A start number of a register for transferring the calling arguments thereof is shifted to a large side not to overlap other external procedures.

At a third stage, information of the register start number for external procedure argument transfer picked up at the second stage is added together with information of a default start number to the module. A place of the addition is stored together with symbol information for external procedure calling in the object file.

At a fourth stage, to call an external procedure during program execution, if the module including the external procedure is loaded, a value obtained by adding together the register start number for argument transfer and an offset value added to a register field number when a currently executed module is loaded is added to a register number field of the external procedure to be loaded.

Here, in compilation of a method 900 (method A) of FIG. 9, the compiler generates a method code 920 executed in a state in which an object variable has been loaded into the register, a method code 910 in which processing of loading the object variable into the register is added to a head of the method code 920, and a method code 930 in which processing of storing the object variable in the memory is added to a tail of the method code 920.

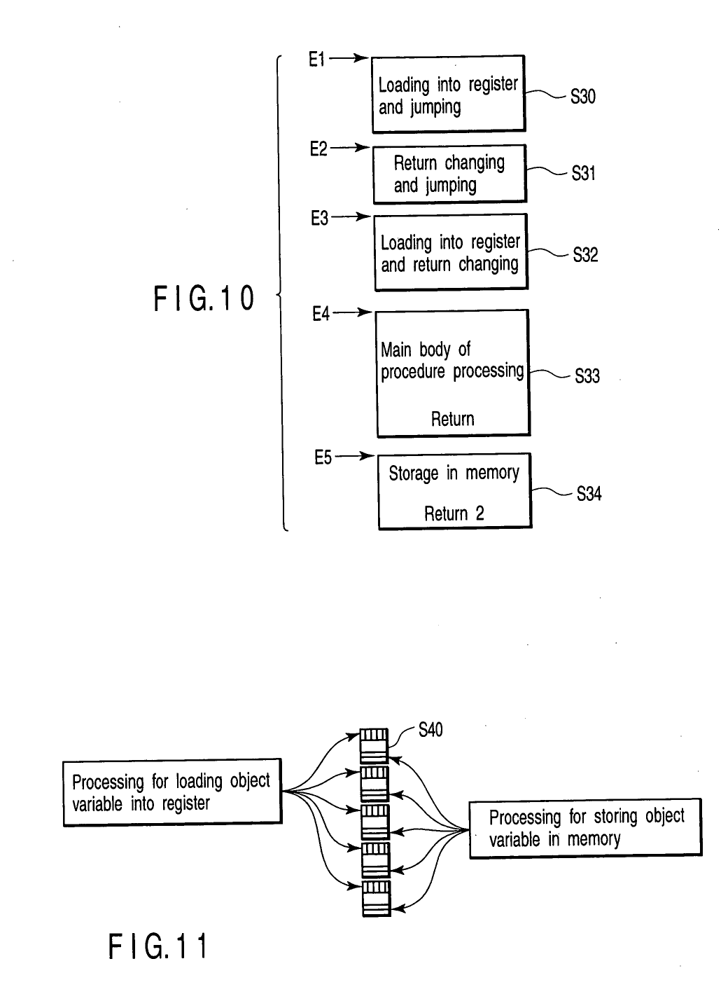

If such operations are carried out by a process shown in FIG. 10, a size can be set equal to a code size of the procedure execution code (920) based on the conventional calling convention. In FIG. 10, E1 to E5 indicate processing entries.

That is, after processing of generating the method code 910 (step S30), return changing processing equivalent to prologue processing is added as the entry E2 of generating the method code 930 (step S31). In the return changing processing, an object variable is loaded to save a return address in the stack, and then the return address is changed into an address 2. This address 2 is set when the object variable is stored in the memory.

As the entry E3 of the method 900, the register is loaded to execute return changing processing (step S32). Further, a main body of procedure processing is set as the entry E4 of the method code 920 (step S33). Then, as the entry E5 of return changing processing, the object variable is stored in a proper place of the memory to execute processing of a return 2 (step S34). The processing of the return 2 is epilogue processing of loading a return address from the stack, and returning (jumping) to the loaded address.

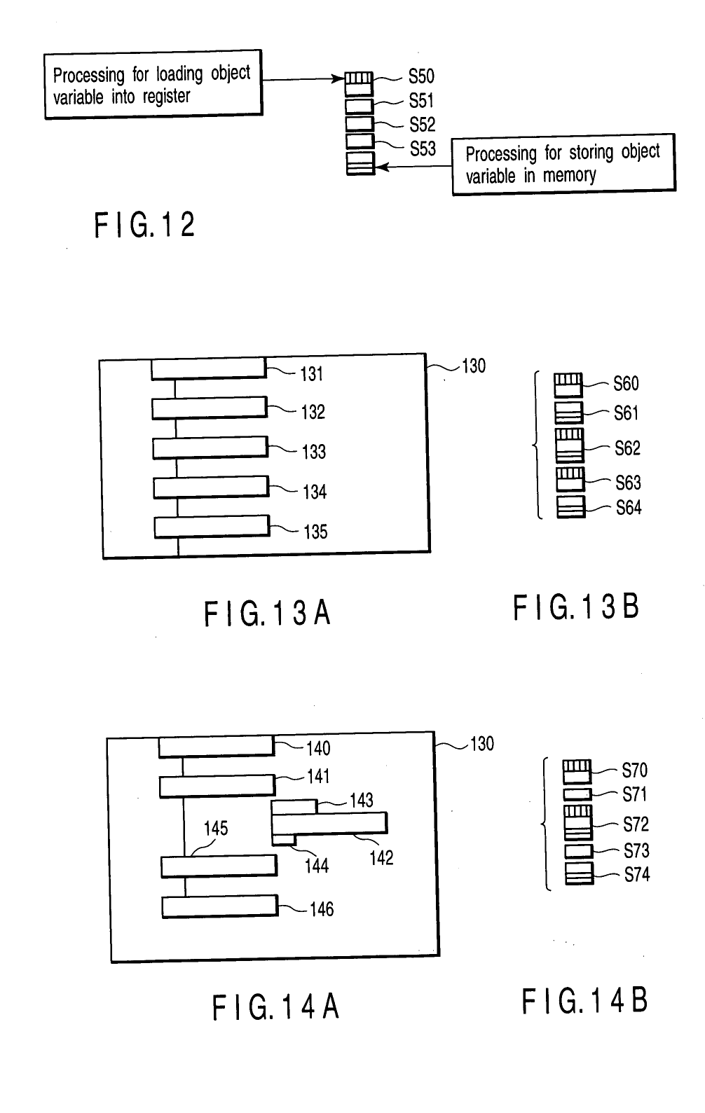

FIGS. 11 and 12 are conceptual diagrams showing sequences of method calling processing.

Normally, as shown in FIG. 11, processing of loading the object variable into the register and processing of storing the object variable in the memory are executed for each calling processing (S40).

On the other hand, as shown in FIG. 12, execution of processing of loading the object variable into the register in first calling processing (S50) eliminates the necessity of loading the object variable from the memory in subsequent method calling processing (S51 to S53). Then, in last method calling processing (S54), processing of storing the object variable in the memory is executed.

Further, FIGS. 13A to 14B show a sequence when it is necessary to call another method (method B) in the middle of the method (method A) calling processing. In FIGS. 13A to 14B, used register numbers are larger from left to right in the register file 130.

Normally, as shown in FIGS. 13A, 13B, in the method (method A) calling processing, processing of loading the object variable into the register at the head of the method code (S60, S63), and processing of storing the object variable in the memory at the tail of the method code (S61, S64) are sequentially executed. If processing of calling another method (method B) (S62) is executed in the midway, a register 133 allocated to the method (method B) has a register number similar to those of registers 131, 132, 134, and 135 allocated to the method (method A).

On the other hand, as shown in FIGS. 14A, 14B, according to the embodiment, in the method (method A) calling processing, processing of loading the object variable into the register is executed in first calling processing (S70), and processing of storing the object variable into the memory is executed in last calling processing (S74).

Then, if processing of calling another method (method B) (S72) is executed in the midway, a register 142 allocated to the method (method B) is shifted to a register number larger than those of registers 140, 141, 145, and 146 allocated to the method (method A).

Incidentally, in FIG. 14A, 143 denotes a register for transferring an argument, and 144 denotes a register for receiving a return value. Thus, it is possible to maintain valid a value of the register allocated to the object of executing the method (method-A) over the method (method B).

As described above, in the microprocessor that comprises a number of general-purpose registers, the register using method is not decided in a fixed manner in accordance with the calling convention, but the procedure is loaded to enable procedure calling without contradiction based on information on the start offset number of the register for procedure calling or the like even if allocation is made to any part of the register file. Thus, it is possible to separately use a number of registers in an effective manner.

Furthermore, if a method of managing the register allocation to each procedure during the execution is applied to a thread or a coroutine, the thread or the coroutine can be switched at a high speed. It is possible to realize execution switching of a particulate degree which executes processing of another coroutine during memory access latency.

(Second Embodiment)

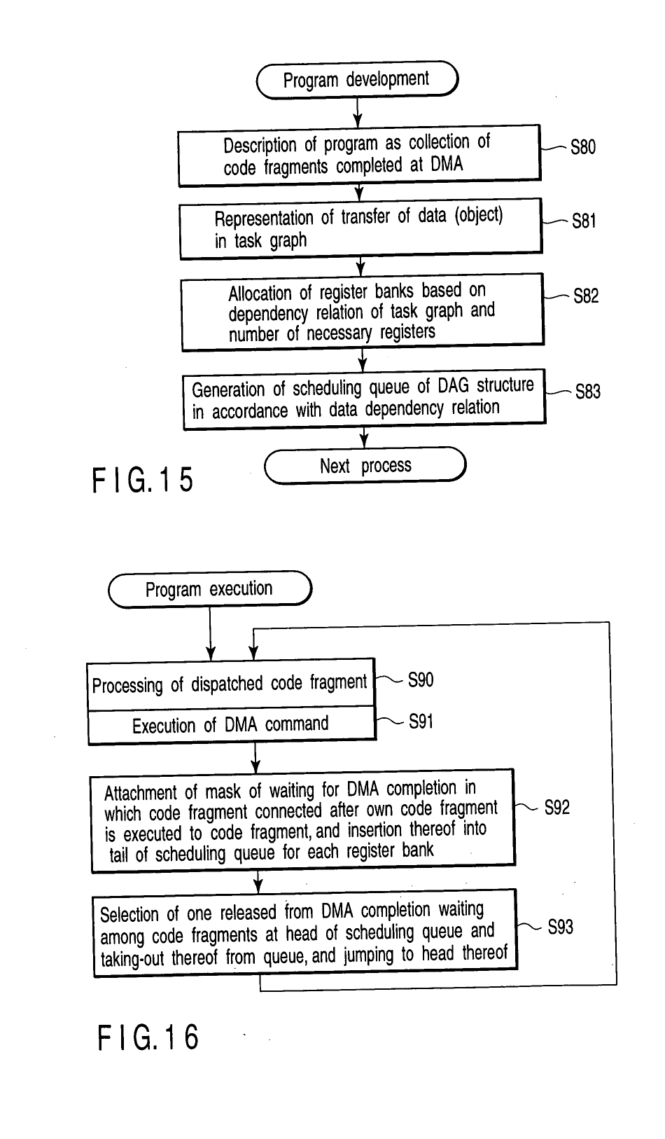

FIGS. 15 to 18 show a second embodiment.

The embodiment relates to a method of creating a program in accordance with a model in which processing is completed by DMA processing during program creation different from the aforementioned multithread model.

A processing unit created by such a model is referred to as a code fragment for convenience.

In the case of the code fragment, execution is started from an entry point, and its execution unit is finished by lastly executing a DMA command. The code fragment specifies a code fragment to be executed next after completion of the lastly executed DMA command. A program creased by collection of such code fragments is compiled and allocated to a register bank included in a register file 130 as in the case of the thread model.

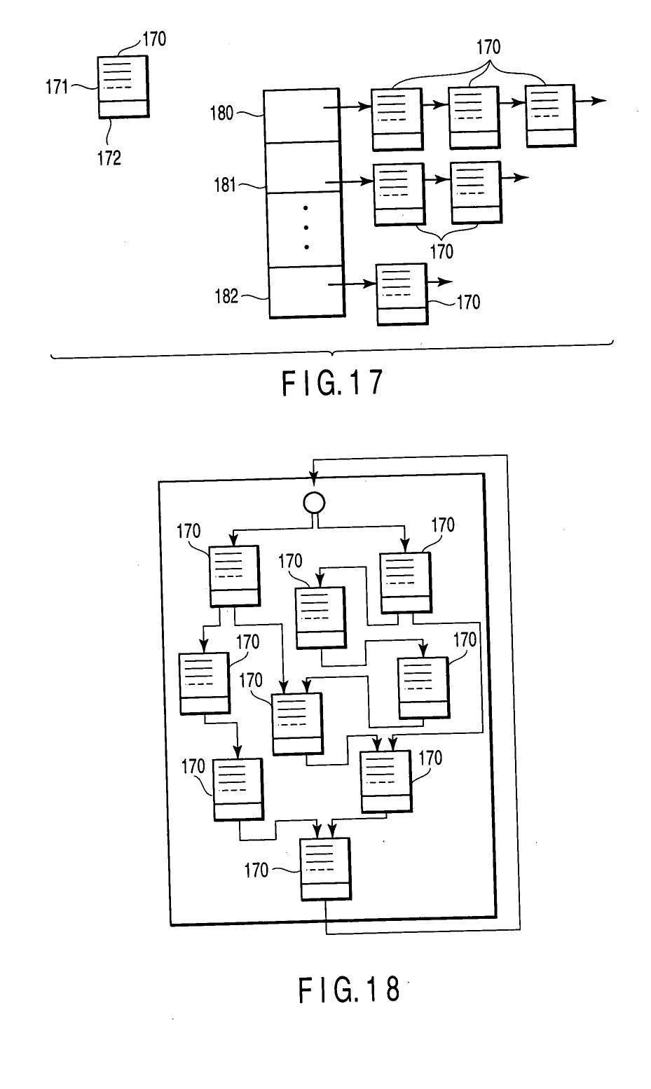

The collection of code fragments is managed by a task graph which indicates a dependency relation of a code fragment 170 to be executed next as shown in FIG. 18. As shown in FIG. 17, the code fragment 170 includes an execution processing section 171 of a thread or the like, and an issuance processing section 172 of a DMA command.

As an execution environment of the code fragment 170, as shown in FIG. 17, the code fragment 170 is loaded into a memory, and a scheduling queue is generated for each of register banks 180 to 182 of the register file 130 in accordance with information of the task graph.

A code fragment scheduler schedules execution of the code fragments by referring to the information of the task graph as shown in FIG. 15. That is, as a process during a program development, a program is described as collection of code fragments completed at a DMA (step S80). Next, transfer of data (object) is represented by the task graph (step S81). Further, the code fragments are allocated to the register banks of the register file 130 based on the dependency relation of the task graph and the number of necessary registers (step S82). Then, a scheduling queue of a DAG structure is generated in accordance with the data dependency relation (step S83).

FIG. 16 shows a program execution process in the code fragment model.

A program dispatcher executes processing of a dispatched code fragment and a DMA command (steps S90, S91). A mark of waiting for DMA completion in which a code fragment connected after its own code fragment is executed is attached to the code fragment, and the code fragment is inserted into a tail of a scheduling queue of each register bank (step S92).

Further, among code fragments at the head of the scheduling queue, a code fragment released from waiting for DMA completion is taken out from the queue, and the process jumps to its head (step S93).

The code fragment may be constituted to be mounted as an object-oriented method. Additionally, an instruction code of the code fragment may be dynamically loaded together with data by the DMA.

Further, it is possible to conceive not a program model assuming a stack such as a C language but a model which maintains a program state by separately using a number of general-purpose registers. In this case, a parallel program such as data flow model capable of naturally describing parallel processing, or an actor model in which an object independently executes a program can be made an efficient program by using a thread or coroutine method of the embodiment.

In short, according to the second embodiment, since there is no need to allocate each processing to the register banks in the program execution by the code fragment model, it is possible to obtain high throughput by properly dividing the program.

Furthermore, programming forms can be selected in accordance with various processing forms, and an increase/decrease in a delay cycle of memory access can be flexibly dealt with by a hybrid processing schedule. Since no stack is used, extra memory management is unnecessary, and loading/unloading of variables into/from the stack is unnecessary.

(Third Embodiment)

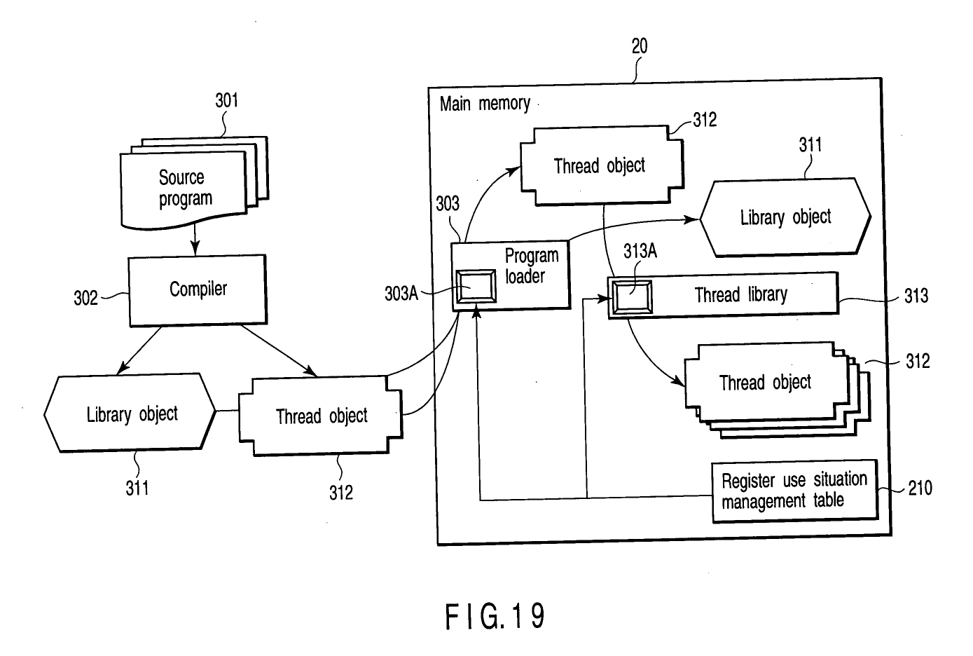

FIGS. 19 to 23, and FIGS. 24A to 24C show a third embodiment.

FIG. 19 is a block diagram showing main portions of an apparatus for program execution according to the embodiment. Components other than the main portions are similar to those of the first embodiment described above with reference to FIG. 1, and thus description thereof will be omitted.

A software constitution of the embodiment comprises a source program 301, a compiler 302, a program loader 303, and a thread library 313.

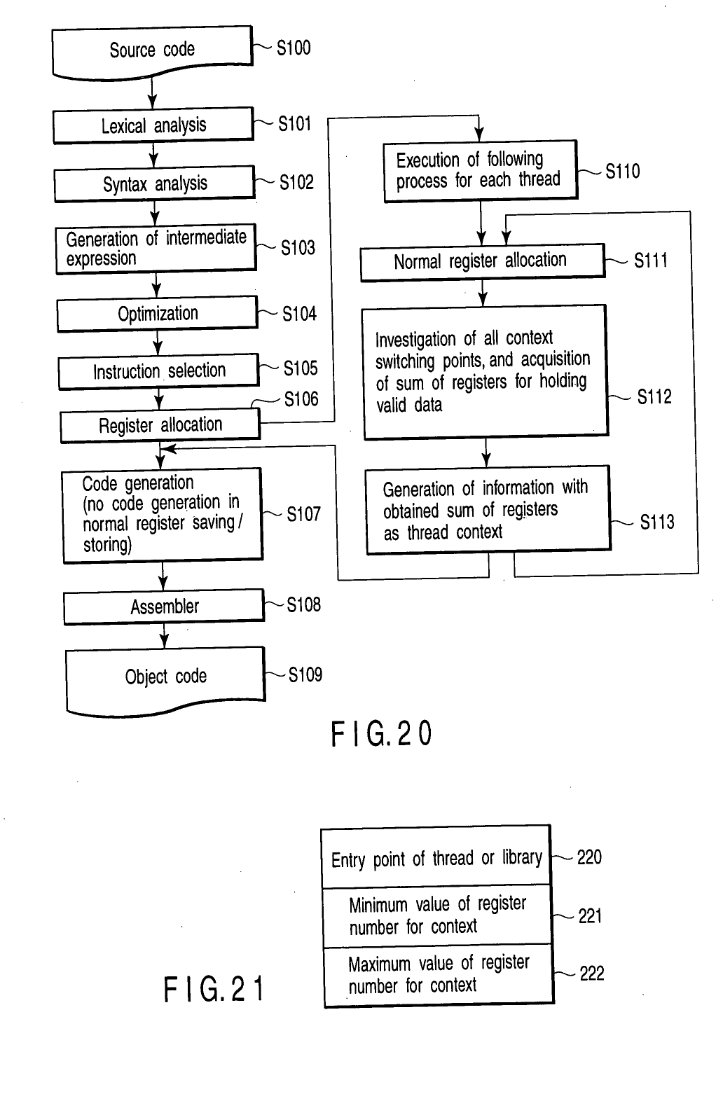

The compiler 302 compiles the source program 301 to generate an object module (object code). The compiler 302 executes processing of adding register information used for a context during the compiling to the object module (object file) (see FIG. 20). The object module includes a library object 311 and a thread object 312.

The program loader 303 loads the object module generated by the compiler 302 into a main memory 20. The program loader 303 includes a routine 303A for rewriting a register number during the loading.

The thread library 313 starts the thread object 312 loaded by the program loader 303. The thread library 313 includes a routine 313A for rewriting a register number at the time of starting.

(Operation Process of Compiler)

FIG. 20 is a flowchart showing an operation process of the compiler 302.

As shown in FIG. 20, the compiler 302 of the embodiment includes a phase of executing normal compilation processing of inputting a source code included in the source program 301 and generating and outputting an object code (steps S100 to S109), and a phase of executing processing of allocating registers (step S106).

The phase of executing the normal compilation processing comprises lexical analysis of the input source code (S101), syntax analysis (S102), intermediate expression generation (S103), optimization (S104), instruction selection (S105), code generation (S107), assembler processing (conversion into machine code, S108), and object code outputting (S109).

The phase of executing the register allocation processing (step S106) includes operations of steps S110 to S113.

In this case, the source program 301 includes a processing step of explicitly specifying a context switching point. For example, a context is switched by a library calling step of “yeield();”.

In the register allocation phase, the compiler 302 sets a source code by a thread unit, and executes the following processing (step S110). That is, after execution of normal register allocation processing, all context switching points are investigated, and a sum of registers which hold valid data at the context switching points is obtained (step S112).

Further, the compiler 302 generates the obtained sum of registers (register information) as information used for a context of a thread (step S113). The compiler 302 adds the register information to the object file. Here, the register information has a structure similar to that shown in FIG. 21, and comprises information 220 indicating an entry point (context switching point) of a thread or a library, information 221 indicating a minimum value of a context register number, and information 222 indicating a maximum value of a context register number.

Now, in FIG. 20, if the generation of the register information by the thread unit is executed not by a thread unit but by a procedure unit, and the context switching point is replaced by procedure calling, it is possible to obtain register information by each procedure unit.

Additionally, in FIG. 20, in the code generation phase (S107), saving/restoring processing of registers are normally executed at the start/end of the procedure or during thread switching. In this case, since the registers can be allocated by thread or procedure units and used by the system of the embodiment, it is possible to omit the code generation for saving/restoring processing.

(Rewriting Process of Register Number)

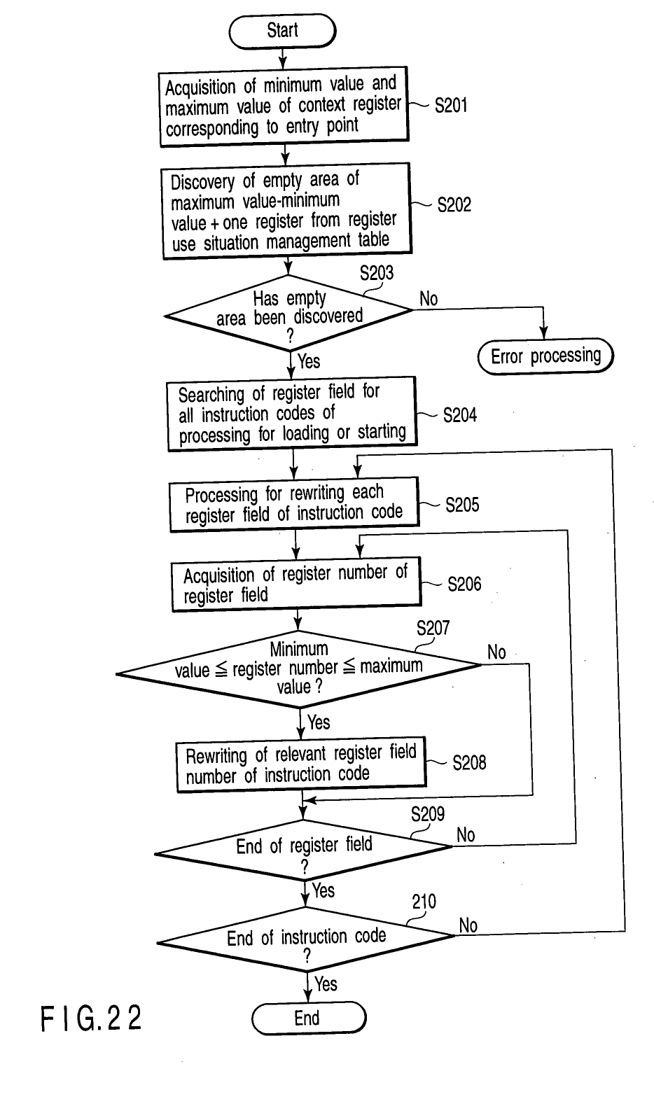

In the aforementioned manner, the program loader 303 loads the object file constituted of object codes generated by the compiler 302 into the main memory 20 during the program execution. During the loading, the program loader 303 executes rewriting processing of the register number by a process similar to that shown in a flowchart of FIG. 22 (execution of routine 303A).

Here, the program loader 303 executes the rewriting processing of the register number by the following process when a dynamically loaded function library is loaded.

To begin with, the program loader 303 obtains a register use area equivalent to the function entry point from register information added to the object file (step S201). That is, the program loader 303 obtains a minimum value and a maximum value of the context register number corresponding to the entry point (see FIG. 21).

Next, the program loader 303 obtains an empty area (empty register) of the memory for allocating resisters from a register use situation management table 210 which has been prepared beforehand (step S202). That is, an empty register area corresponding to a register number of a range of “maximum value-minimum value+1” is discovered in the register use situation management table 210.

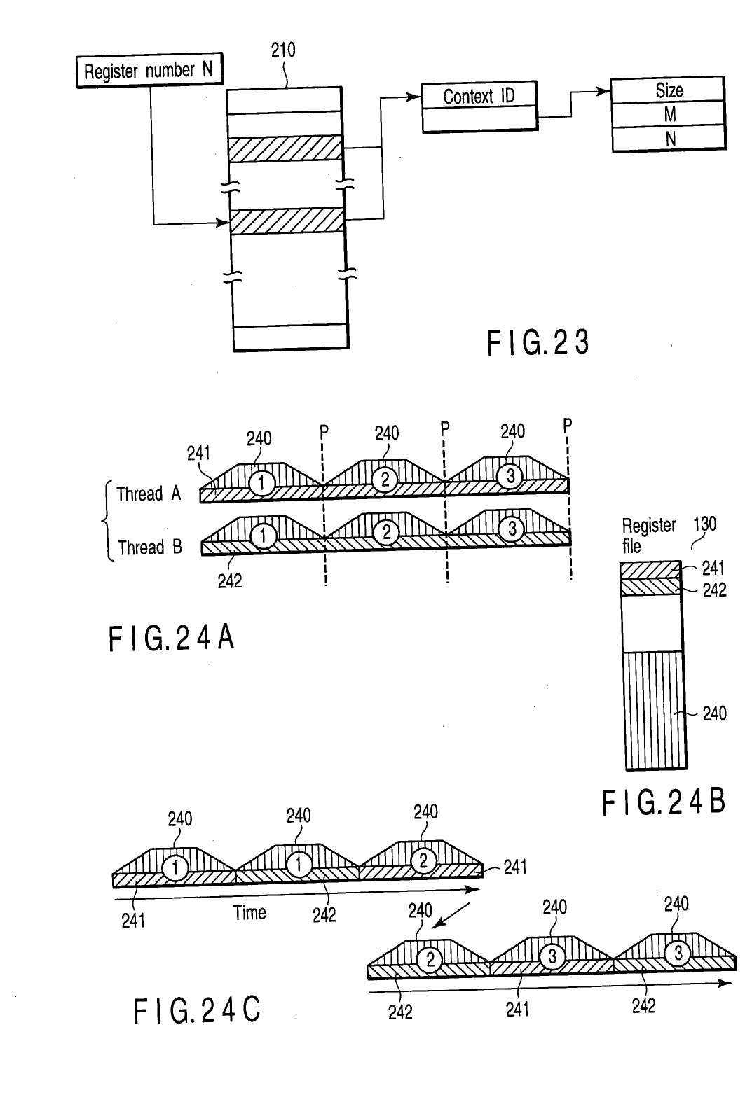

For example, the register use situation management table 210 has a structure similar to that of FIG. 23. That is, the register use situation management table 210 comprises ID information for identifying a context corresponding to a register number N, and information indicating a size of a register area for the context.

If a sufficient empty area (empty register) for allocation cannot be secured, the program loader 303 executes predetermined error processing (NO in step S203). In this case, in place of the error processing, the program loader 303 may prepare a module compiled as in the case of the conventional procedure, and continue normal program loading processing.

On the other hand, if a sufficient empty area for register allocation is discovered, the program loader 303 sequentially searches register fields of all instruction codes to be loaded (or started) into the memory (YES in step S203, S204). Next, the program loader 303 executes rewriting processing of a register number for each register field (step S205).

That is, the program loader 303 obtains a register number of a register field (step S206). The program loader 303 determines whether the register number is included or not in a range of a minimum value and a maximum value of the context register number (step S207). If it is determined that the register number is a register allocated as the context register number, the program loader 303 rewrites the register number of the register field of the instruction code (step S208). Here, the register allocated for the procedure context means a register allocated as a sum of registers over which procedure calling is valid.

In the aforementioned manner, the program loader 303 executes rewriting processing of the register numbers for all the register fields of the instruction codes, and all the instruction codes (steps S209, S210). Accordingly, the register number recorded as the context register of the object file and the register numbers used for the other object fields are adjusted not to overlap each other.

For the function library loaded in the aforementioned manner, library processing can be executed without any register saving/restoring at the start/the end.

Incidentally, in addition to the case of loading the function library, in the case of a thread object, the program loader 303 executes rewriting processing by a process similar to the above. However, in the case of the thread object, there are two methods, i.e., a method of rewriting a register number during program loading, and a method of rewriting a register number at the time of starting the thread.

As compared with the method of rewriting at the time of starting the thread, the method of rewriting the register number during the loading is effective when a plurality of threads for executing loaded codes are not generated simultaneously. On the other hand, when a plurality of threads are started from one code, the method of rewriting at the time of starting the thread is effective because there is a need to rewrite the register number at the time of starting the thread.

(Execution Situation of Program)

FIGS. 24A to 24c show a concept of a register use situation during program execution according to the embodiment.

FIG. 24B shows a constitution of the register file 130.

For convenience, the embodiment assumes a case of starting a thread A and a thread B by thread units as program execution. The compiler 302 differentiates a working register 240 used in common by the thread A and the thread B from registers 241, 242 allocated as thread contexts to the threads A, B in the register file 130, and executes recording in the object file. The working register 240 is a register which does not hold a value valid at the context switching point among registers used by the threads.

When the threads A, B are loaded into the memory 20, the program loader 303 allocates parts of the register file 130 as thread context registers 241, 242, and uses the remainder as a working register 240.

FIG. 24A shows a situation of using the working register 240 usable in common and the registers 241, 242 allocated to the threads when the threads A, B execute operations 1 to 3. A code “P” denotes a context switching point.

FIG. 24C shows a situation of time-division execution of the threads A, B.

That is, the thread A is started to finish the operation 1. When a context is switched by a library calling step of, e.g., “yeield( )” (point P), the process is switched to the operation 1 of the thread B.

The thread B executes the operation 1 by using the register 232 of an area different from that of the register 241 allocated to the thread A. Thus, no register saving/restoring is necessary when the thread A is switched to the thread B. Thereafter, similarly, the operations 1 to 3 are continued while the threads A, B are switched in accordance with context switching points.

An effect of such high-speed thread switching is that, for example, if access is made to a memory of large access latency immediately before the thread A is switched to the thread B, and data is transferred near a CPU core while the thread B is moved, another processing can be carried out during the latency to improve throughput of the CPU.

The embodiment has been described by way of the method of dynamically allocating the registers by library or thread units. However, the registers can be dynamically allocated by using object instances in the object-oriented program as units.

The information added to the object may be all specifically necessary register numbers in place of the minimum value and the maximum value. In practice, since such registers can be collected into one area by the compiler, the information of the minimum value and the maximum value alone is enough.

If there is a nest relation of procedure calling, or restrictions on simultaneous thread execution, registers of the same area can be allocated to procedures or threads which cannot be present simultaneously.

In short, a feature of the embodiment is that the register number of the context portion of the dynamically connected library or thread is rewritten during the program loading or at the time of starting the thread. Thus, processing by a program can be switched by preventing collision between the registers without retreating or restoring registers which is necessary at the time of calling a procedure and at the time of switching a thread context. In this case, it is possible to increase register use efficiency by defining a register using method.

Since costs of switching processing by a program can be reduced, it is possible to realize a high-performance program while maintaining modularity of the program components. Moreover, the increased register use efficiency increases the number of registers used per unit processing, and more efficient codes can be generated.

Furthermore, if used together with a high-speed scheduling facility, there is no influence on performance even when processing is switched by very fine units. Accordingly, if another processing is scheduled to be executed during the latency of memory access, throughput of the processor is not bound by the latency of the memory access.

Effects of the embodiments are summarized as follows.
(1) It is possible to realize high-speed thread context switching which executes no register saving/restoring.
(2) It is possible to realize optimization of register allocation between dynamically called program modules.
(3) It is possible to allocate necessary registers for each thread context or dynamic library.
(4) The registers allocated to the threads are registers alone which hold values at the time of switching a context, and the other register can be shared as a working register between threads.
(5) A programmer can explicitly switch a context.
(6) Optimization can be realized to reduce the number of registers present at context switching points during compiling.
(7) At the time of starting a thread or during loading, an unused register area is discovered, and a register number allocated to a thread context is rewritten. Thus, it is possible to realize optimization of register allocation between threads.

The program execution apparatus of the first to third embodiment are useful especially when they are applied to the microprocessor of a multithread system which comprises a number of registers such as general-purpose registers. Specifically, the registers are effectively used to increase register use efficiency, thereby improving latency of memory access. Thus, it is possible to improve execution performance of a program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An apparatus, comprising:
a storage unit which stores an execution unit module of a program;
a register file constituted of a group of registers necessary for the execution unit module; and
a register allocation unit which creates start information indicating a start of a register number of the register file based on the number of registers used by the execution unit module, and allocates registers to each execution unit module from the register file in accordance with the start information.

2. The apparatus according to claim 1, wherein the execution unit module is a program unit module of a thread unit or a coroutine unit.

3. The apparatus according to claim 1, wherein the register allocation unit converts the execution unit module into a program code by using the start information during program loading in which the execution unit module transferred to the storage unit is loaded from the program file into a main memory.

4. The apparatus according to claim 1, wherein:
the register allocation unit creates instruction code offset data in which an offset value is set to specify the start information for each type of instruction format by using the start information of the register number, and
executes processing of adding the instruction code offset data to all instruction codes included in the execution unit module.

5. The apparatus according to claim 1, wherein the start information is a start offset number of a register for procedure calling.

6. A microprocessor comprising:
a local memory which stores an execution unit module transferred from a main memory among execution unit modules of a program loaded into the main memory;
a memory controller which executes data transfer from the main memory to the local memory;
a register file constituted of a group of general-purpose registers necessary at the time of execution of the execution unit module; and
a register allocation unit which allocates registers included in the register file to each execution unit module in accordance with the number of registers used by the execution unit module and start information indicating a start of a register number for procedure calling during program loading from the program file into the main memory.

7. The microprocessor according to claim 6, wherein:
the register allocation unit creates instruction code offset data in which an offset value is set to specify the start information for each type of instruction format by using the start information of the register number during the program loading, and
executes processing of adding the instruction code offset data to all instruction codes included in the execution unit module.

8. The microprocessor according to claim 6, wherein the execution unit module is an execution processing unit program obtained by dividing a program, executes a facility of issuing a DMA command to execute direct memory access (DMA) transfer from the main memory to the local memory, and finishes divided execution processing before execution completion of the DMA command.

9. A method of program execution for a microcomputer which comprises a local memory to store an execution unit module of a program, and a register file constituted of a group of registers necessary for the execution unit module, the method comprising:
obtaining start information indicating a start of a register number from the register file based on the number of registers used by the execution unit module; and
allocating registers included in the register file to each execution unit module in accordance with the start information.

10. The method according to claim 9, wherein the allocating includes addition of the start information to the execution unit module during program loading in which the execution unit module transferred to the local memory is loaded from a program file into a main memory.

11. The method according to claim 9, wherein the allocating includes:
acquisition of an offset value to specify the start information;
creation of instruction code offset data in which the offset value is set in a field of the register number for each type of an instruction format by using the start information of the register number; and
execution of processing of adding the instruction code offset data to all instruction codes included in the execution unit module.

12. The method according to claim 9, the microprocessor including a program execution facility of a multithread system, further comprising:
obtaining an offset value to set a start of a register number used by a thread unit module among register banks included in the register file;
creating instruction code offset data in which the offset value is set for each type of instruction format; and
executing processing of converting all instruction codes included in the threat unit module into program codes by using the instruction code offset data.

13. An apparatus, comprising:
a memory which stores a program;
a compiler which adds register information for allocating a context register based on a context switching point to an object file when the object file constituted of object codes is created from a source program including the context switching point; and
a register allocation unit which obtains the register information from the object file generated by the compiler, and allocates a register area used as the context register to an empty area of the memory means based on the register information.

14. The apparatus according to claim 13, wherein:
the compiler includes a phase of executing normal compiler processing and a phase of executing register allocation processing, and
generates a sum of registers holding valid data at the context switching point as the register information in the phase of executing the register allocation processing.

15. The apparatus according to claim 13, wherein the register allocation unit is included in a program loader which loads the object file generated by the compiler into the memory.

16. The apparatus according to claim 13, wherein the register information includes information indicating the context switching point, a maximum value of a register number indicating a range of a register area used as the context register, and a minimum value of the register number.

17. The apparatus according to claim 13, wherein:
the compiler compiles a thread object of a thread unit from the source program, and
the register allocation unit is included in a thread library which executes the thread object generated by the compiler.

18. The apparatus according to claim 13, wherein the register allocation unit secures an empty memory area equivalent to a range of a register area used as the context register in the memory by using table information prepared in the memory to manage a register use situation.

19. The apparatus according to claim 13, wherein the compiler records a register used as the context register and a register used for the other purpose separately in the object file.

20. A method of program execution for a microprocessor which comprises a memory to store an object file prepared by compiling a source program, and a register file to secure a group of registers necessary for an execution unit module of the object file, the method comprising:
adding register information for allocating a register used as a context register based on a context switching point to the object file when the object file constituted of object codes is generated from the source program including the context switching point;
loading the object file into the memory means; and
obtaining the register information from the object file loaded into the memory, and allocating a register area used as the context register based on the register information to the register file.
